(19) United States
(12) Patent Application Publication
(10) Pub. No.: US 2008/0109583 A1
(43) Pub. Date: May 8, 2008

(54) HIGH PERFORMANCE SERIAL BUS DATA RECORDER

(75) Inventor: William E. Flanery, St. Petersburg, FL (US)

Correspondence Address: MERCHANT & GOULD PC, P.O. BOX 2903, MINNEAPOLIS, MN, 55402-0903, US

(73) Assignee: UNIVERSITY OF SOUTH FLORIDA, TAMPA, FL (US)

(21) Appl. No.: 11/968,977

(22) Filed: Jan. 3, 2008

Related U.S. Application Data
(63) Continuation of application No. 11/046,888, filed on Feb. 1, 2005, now abandoned.
(60) Provisional application No. 60/481,993, filed on Feb. 2, 2004.

(51) Int. Cl. G06F 13/38

(52) U.S. Cl. 710/66

(57) ABSTRACT

A Firewire data recorder device in which contains a small electronic circuit that stores digital data onto a Firewire hard disk drive. The recorder is designed to be broadly applicable to many data storage applications, and takes in 16-bit parallel data and writes it to the hard drive at up to 35 Megabytes per second. Data rate is limited by the Firewire protocol and the target hard drive. The recorder device does not require that a host computer be attached. A programmable logic device is used to rapidly format the data structures and transfer data from the source onto the Firewire bus for storage.

This application is a continuation of U.S. application Ser. No. 11/046,888, filed Feb. 1, 2005, which claims priority to U.S. provisional application No. 60/481,993, filed Feb. 2, 2004. The entire disclosure of each of these applications is herein incorporated by reference.

This invention was made with U.S. government support under grant number N00014-96-1-5020 awarded by the United States Office of Naval Research. The U.S. government has certain rights in the invention.

### BACKGROUND OF THE INVENTION

1. Field of the Invention

The present invention relates to a Firewire (IEEE-1394) data recorder device that allows virtually any digital data to be stored directly onto a Firewire hard drive. This is accomplished without a host computer and therefore is smaller, faster, uses less power, and is not prone to operating system failure. Primary application is for mobile data collection such as scientific equipment, video cameras, or audio recording.

2. Description of the Background

Firewire, also know as IEEE-1394, is a high-speed serial bus. Through its four-wire connection, Firewire can transmit 400 Megabits per second. When data is written to a 1394 hard drive, a protocol called SBP-2 (Serial Bus Protocol, version 2) is used. SBP-2 is counter-intuitive in that data is not written by the host to the hard drive, but instead data is stored in the host's memory and then the hard drive is commanded to read it from the host's memory and store the data on it's disks. This presents several road blocks to high-speed data storage. When using a typical microcontroller-based, off-the-shelf, FireWire controller, data must first be read in from the microcontroller's IO pins and stored in microcontroller (MCU) memory. The MCU must inform the HD to fetch the data, then it waits for the HD to request the data. Finally, the MCU must read the data out of memory and transfer it to the hard disk drive. The problem arising is that even a very fast microcontroller is too slow to handle large volumes of data quickly. Thus, a need exists for a small data recorder having high storage speed.

### SUMMARY OF INVENTION

Accordingly, it is an object of the present invention to provide a high-speed and compact data recorder. In more detail, the present invention provides a Firewire data recorder, which contains is a small electronic circuit that stores digital data onto a Firewire hard disk drive. It is designed to be broadly applicable to many data storage applications. It takes in 16-bit parallel data and writes it to the hard drive at up to 35 Megabytes per second. Data rate is limited by the Firewire protocol and the target hard drive. The device does not require that a host computer be attached. A programmable logic device is used to rapidly format the data structures and transfer data from the source onto the Firewire bus for storage.

### BRIEF DESCRIPTION OF THE DRAWINGS

FIG. 1 is a diagrammatic of view of the SD-IO-400, (MindReady Solutions, LLC), design known in the art.

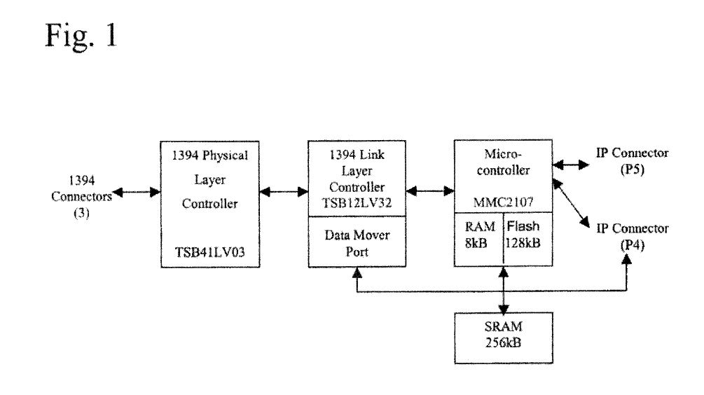

FIG. 2 is a diagrammatic view of the Data Recorder Design in accordance with the present invention.

### DETAILED DESCRIPTION OF THE PREFERRED EMBODIMENT

### Definitions

API Application Programming Interface

CPLD: Complex Programmable Logic Device

FIFO: First In First Out. A memory type where data is stored at one location and retrieved at another. The first data to be stored is the first data to be removed. In this document, FIFO refers to a hardware FIFO memory chip.

FireWire: the brand name owned by Apple Computer for the IEEE-1394 Serial Bus. Also known as IEEE-1394, 1394, or Serial Bus.

FPGA: Field Programmable Gate Array

Hard Disk: the actual magnetic platters that store data inside the hard drive.

Hard Drive: a standard hard disk drive, commonly used in personal computers, also called HD or HDD. In this document, hard drive usually refers to the 1394-to-IDE bridge.

Link Layer Chip in the current Implementation, a TSB12LV32 integrated circuit from Texas Instruments.

M-CORE: is a Motorola microcontroller, also called an MCU

MCU: MicroController Unit, also called a microcontroller; in this implementation a Motorola/MCore MMC/2107.

ORB: Operational Request Block, a data structure defined by SBP-2 that encapsulates a command for the target device.

RBC: Reduced Block Commands. A standard that defines the format of data structures that are commands for a hard drive, or similar device.

SBP-2: Serial Bus Protocol, version 2. A protocol layer commonly used for encapsulating data or commands from one device to another a cross the 1394 Bus.

The present invention is a device designed to be a compact, versatile, high-speed, high-volume data recorder. The device will take in digital data and record it directly to an IEEE 1394 (AKA FireWire) hard disk drive, for example.

One exemplary embodiment of the device is a modification of the SD-IO-400 (MindReady Solutions Inc.) board and uses an FPGA to handle the high-speed data transfer. Other implementations, utilizing different components, are explicitly within the scope of the present invention.

The current implementation describes a method of writing data to the hard drive using only Asynchronous Transfers to the hard drive because existing commercial hard drives only operate Asynchronously. Other implementations utilizing other transfer schemes, such as Isochronous Transfers, are within the scope of the present invention. The current version of the IEEE-1394 standard limits the data transfer rate to around 35 MB/s. Future versions of the 1394 standard, such as IEEE-1394-B, will allow significant speed improvements. All implementations of the present invention utilizing current and future versions of the IEEE-1394 standard are within the scope of the present invention.

One advantage of the present invention over existing technology is the reduced size. A single PC board in accordance with the present invention approximately measures about 3″×5″ for the prototype, excluding hard drive. Even smaller sizes are obtainable, if needed.

An additional advantage of the present invention is the increase in storage speed. Rates are in excess of 30 MB/s, and up to about 38 MB/s. By comparison, a typical personal computer (in 2003) can transfer data to a Firewire hard drive at about 10 MB/s. Even a very fast PC can only store data onto an external hard drive at about 25 MB/s. The bottleneck is usually the PCI bus, so if the user is using a PCI-based data acquisition card (almost always), then the transfer rate gets cut in half. The present invention is capable of 35 MB/s, for example, because it does not use a PCI bus, and therefore does not have this limitation.

Another advantage of the present invention is the high data capacity. Up to 60 hard drives can be daisy-chained together resulting in (500 GB×60=30,000 GB) 24 30 Terabytes with current drive technology.

Yet another advantage is the reduced power consumption. Power consumption is reduced because a computer system is not a requirement for operability.

An additional advantage is the increased reliability of the system due to the relative simplicity of the implementation and the elimination of an Operating System.

In accordance with one embodiment, the present invention is employed for underwater applications. The present invention has several benefits for underwater applications. First, it only requires six wires, four for data and two for power, which allows the use of smaller underwater connectors and fewer connections to fail. Second, the present invention was designed to allow devices to communicate without the need for a computer to be attached. This allows space and power-consumption savings. Third, the present invention is a scalable architecture, allowing more than sixty hard drives to be attached for virtually unlimited data capacity. Fourth, the use of an external hard drive allows the researcher to simply detach the drive from the present invention and plug it into their analysis computer, eliminating a need for massive data offloads, and providing high-capacity data storage, especially important in field applications.

The FPGA is placed between the M-CORE Microcontroller and the TSB12LV32 Link Layer chip. This allows the microcontroller to handle normal operations (controlling other parts of an encompassing device such as sensors, or accessing other FireWire devices that may be on the bus), while the FPGA implements specific parts of the 1394 transaction layer for moving data to the hard drive at high speed. As another embodiment, it is possible to implement all function in the FPGA. In yet another embodiment, it may also be possible to have a microcontroller handle all functions.

During normal operation, the FPGA is in “Transparent Mode”, where any signal on an input pin is immediately applied to a corresponding output pin. When the user wants to store data to the hard drive, the MCU initializes the transfer and. generate ORBs that contain RBC commands to be sent to the hard drive. To achieve 35 MB/s, however, in this embodiment, the FPGA must create the ORBs because the microcontroller is too slow. The ORB instructs the hard drive to use IEEE-1394 transactions to request data from the Data Recorder and store that data onto disk. This command specifies a memory address on the Data Recorder where the data to be transferred is located. The address does not physically exist, but is a “virtual address”. When the FPGA reads a packet from the Link Layer chip, it inspects the packet to determine if it is requesting data from a virtual address. If so, the FPGA uses the DataMover port on the Link Layer chip to transfer data from the FIFO onto the Serial Bus. If there is data available in the FIFO when the 1394 read request is received from the hard drive, the FPGA will respond with a “split transaction with concatenated Subaction”, as described in section 3.6.2.3 in the IEEE 1394-1995 standard. If data is not available, it responds with ack_busy_X and resume the transaction when data becomes available. Data must FIFO-buffered to the Link chip's Data Mover port. The current implementation includes a FIFO chip, however other implementations, omitting or utilizing different components, are within the scope of the present invention.

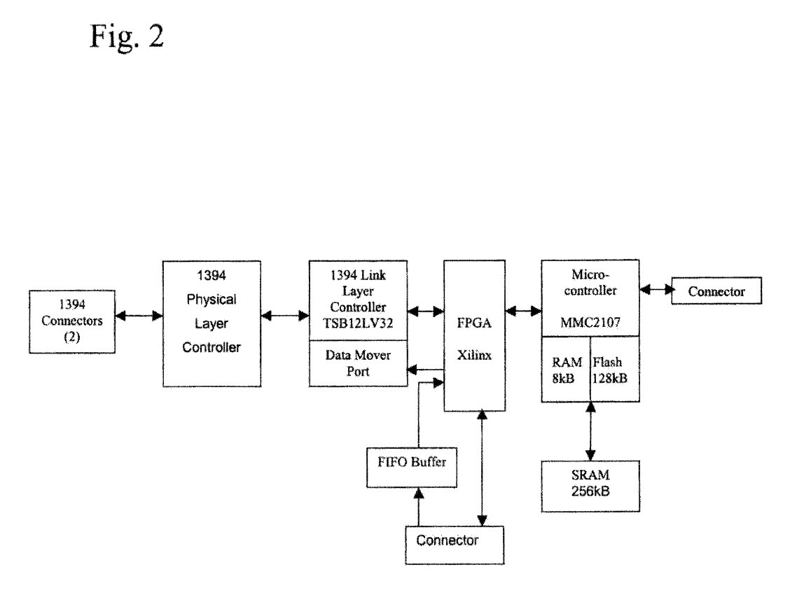

With reference to FIG. 2, one embodiment in accordance with the present invention contains the following significant components implemented in addition to the SDIO400 design: 1) FPGA (or CPLD) 2) FPGA's EPROM 3) Programming connector for FPGA In-Circuit-Programming 4) Clock for the FPGA 5) Additional connector to give access to some FPGA pins 6) FIFO memory buffer in accordance with one embodiment of the present invention. The M-CORE utilizes API functions to cause the MCU to indicate to the FPGA to begin the high-speed data transfer. SBP-2 commands are generated for writing to the hard drive (RBC WRITE (10)). The commands tell the HD to read data from an address that does not exist on the board, i.e. virtual address, appending new ORBs such that they cannot be executed out of order. For example, for ORBs, A, B, C, and D, place A in the ORB queue and ring the target's doorbell. When A begins executing and fetching data, append B to the list and await a completion status for A. Then append C. When B is complete, append D. ad infinitum.

The FPGA in accordance with the present invention implements parts of the 1394 transaction layer for 1394 READ and WRITE operations. The implementation comprises functions to create a 1394 WRITE request to ring the target's SBP-2 doorbell or store the address of the waiting SBP-2 command. It will also cause the Link Layer chip to send the 1394-WRITE request and wait for receipt acknowledgement. The 1394-READ commands from the HD will be either command fetches or data fetches as determined by the FPGA, based upon which virtual address the 1394-READ points to. Otherwise the 1394-READ is not related to the data transfer, and control will pass to the MCU.

The present invention has broad application for data collection in the following exemplary areas. The list below is not intended to be limitative, but only exemplary.
1. Digitized sonar waveforms
2. Automobile testing
3. Remotely-located sensor stations
4. Autonomous aircraft
5. Autonomous submersibles
6. Surveillance vehicles (military or civilian)
7. Police cars (to replace video tape. Can record from multiple video cameras and microphones simultaneously, as well as GPS location, velocity, radio conversations, etc.)
8. Video recording
9. Audio recording
10. Digital photography

Thus, in accordance with the present invention, the present data recorder device may be configured with any of digitized sonar waveforms, automobile testing, remotely-located sensor stations, autonomous aircraft, autonomous submersibles, surveillance vehicles, police vehicles, video recording, audio recording or digital photography. The means by which this configuring is arranged may be by any conventional means well known to one of ordinary skill in the art.

Further, in accordance with the present invention, conventional code may be written to make the FPGA handle the matter of creating a new command packet to inform the hard drive to fetch more data instead of having this performed by the microcontroller.

The data recorder device of the present invention may be used with advantage in any application where data must be stored in a small space, yet affording the advantage of very high capacity and high data rate. There is nothing currently available that can exceed 8 MB/s in a similar size, i.e., suitable for a portable device. Rather, anything currently available that can exceed 8 MBs is intended to operate on/with a desk top computer.

Although the present data recorder device will be most commonly used containing a 3″×5″ electronic circuit size, it is also within the scope of the present invention to implement all functions in a single FPGA device of a size of less than 2 square inches which requires the necessary FPGA programming code, which is within the skill of the artisan.

For further definitions and terms related to BUS principles and systems, see NEWTON's Telecom Dictionary by Harry Newton (1998). Finally, however, as used herein, the term “speed” means a storage speed of at least 20 MB/s, and preferably higher. The term “high volume” refers to the high data storage capacity of the present data recorder device, particularly with daisy chaining.

Thus, the present invention provides a device implementing both existing and future revisions to the Firewire protocol, such as Firewire 2 (IEEE-1394B), of similar design, yet capable of much higher data storage speeds.

The present invention also provides a device of similar design capable of implementing Isochronous Transactions, an anticipated capability of future hard drives, in addition to the Asynchronous-transactions-only hard drives currently available.

The present invention also provides a method of storing data provided in any format; for example, serially, 8-bits parallel, 16-bits parallel, 24-bits parallel and 32-bits parallel, etc.

The present invention also provides a data recorder with integrated signal processing, such as analog-to-digital converter, digital converter, video digitizer, Digital Signal Processor, Internet Protocol Processor, audio format converter, fiber optic, wireless recorder, etc.

Having described the present invention, it will be apparent to one of ordinary skill in the art, that many changes and modifications may be made to the above-described embodiments without departing from the spirit and the scope of the present invention.

What is claimed:

1. A high-speed data recorder device, which is capable of storing digital data directly onto a Firewire hard drive.

2. The data recorder device of claim 1, which stores data from means configured for digitized sonar waveforms, automobile testing, remotely-located sensor status, autonomous aircraft, autonomous submersibles, surveillance vehicles, police vehicles, video recording, audio recording or digital photography.

3. The data recorder device of claim 1, having a storage speed of up to 30 MB/s.

4. The data recorder device of claim 3, having a storage speed of up to about 38 MB/s.

5. The data recorder device of claim 1, which comprises an electronic circuit having a size of no more than about 3″×5″.

6. The data recorder device of claim 5, which comprises an electronic circuit having a size of less than 2 square inches.

7. The data recorder device of claim 1, which is portable.

8. The data recorder device of claim 1, which is a video recorder.

9. A method of storing digital data at high speed onto a Firewire hard drive, which comprises the step of storing the digital data onto a Firewire hard drive from the data recorder device of claim 1.

10. The method of claim 9, wherein the data recorder device is a video recorder.

11. The method of claim 9, wherein the high speed is at least 30 MB/s.

12. A device implementing revisions to Firewire protocol which exhibits enhanced data storage speeds.

13. The device of claim 12, wherein the revisions are to Firewire 2 (IEEE-1394B).

14. The device of claim 12, which implements Isochronous transactions and Asynchronous transactions.

15. A method of storing data in any format, which comprises storing the data with the high-speed data recorder device of claim 1.

16. The method of claim 15, wherein the format is 8-bits parallel.

17. The method of claim 15, wherein the format is 16-bits parallel.

18. The method of claim 15, wherein the format is 24-bits parallel.

19. The method of claim 15, wherein the format is 32-bits parallel.

20. A high-speed data recorder device having integrated signal processing,

21. The high-speed data recorder device of claim 20, wherein the integrated signal processing is selected from the group consisting of analog-to-digital converter, video digitizer, Digital Signal Processor, Internet Protocol Processor, format connecter, fiber optic and wireless receiver.
